(19) United States
(12) Patent Application Publication
(10) Pub. No.: US 2025/0118225 A1
(43) Pub. Date: Apr. 10, 2025

(54) SWATCH TAG

(71) Applicant: BEN HONG, GARDENA, CA (US)

(72) Inventor: BEN HONG, GARDENA, CA (US)

(21) Appl. No.: 18/626,011

(22) Filed: Apr. 3, 2024

Related U.S. Application Data
(63) Continuation-in-part of application No. 18/481,484, filed on Oct. 5, 2023, now abandoned.

(51) Int. Cl. G09F 3/00; G09F 3/02

(52) U.S. Cl. CPC G09F 3/00; G09F 2003/0208; G09F 2003/0264; G09F 2003/0272

(57) ABSTRACT

A net swatch tag system has a container containing a net. The container has a lid that is removable and attaches to the container. A swatch tag is connected to the container. The swatch tag retains a swatch material corresponding to the net. A base is formed on the swatch tag. The base has a contrast background section. The swatch material is mounted over the contrast background section.

### TECHNICAL FIELD

The present invention is in the field of tags.

### DISCUSSION OF RELATED ART

Cast nets are often displayed in transparent containers, however due to their complicated construction and packing, it's oftentimes difficult for a customer to determine the material which requires the customer to open the cast net container. The cast net container is sealed for security, and potential customers opening the cast net containers create a problem at the retail level.

### SUMMARY OF THE INVENTION

A net swatch tag system has a container containing a net covered by a lid. The lid is removable and attaches to the container allowing a user to transport the net inside the container. The swatch tag is connected to the container. The swatch tag retains a swatch material for displaying a sample of the net, and the swatch material corresponds to the net. The swatch tag has a base preferably with a contrast background section. The swatch material is mounted over the contrast background section. A cover is formed on the swatch tag which is configured to overlay the base and sandwich the swatch material between the cover and the base. The cover has a cover opening, so that the cover opening aligns to the contrast background section.

The cover includes a first cover section, a second cover section, a third cover section and a fourth cover section, wherein the base includes a first base section, a second base section, a third base section, and a fourth base section, wherein the first cover section, second cover section, third cover section, fourth cover section, are elongated and perpendicular to each other.

The swatch material adheres to the base at an adhesive ring. The adhesive ring circumscribes the contrast background section. The swatch material has a translucent core. A first cover section fits over a first base section. A second cover section fits over a second base section. A third cover section fits over a third-base section. The cover is preferably square or rectangular but could be circular or hexagonal or some other shape. The swatch material includes a connected area having a grid arrangement, and terminal branches extending to branch fringes. The branch fringes extend outwardly to edge tips. Edge gaps are formed between the edge tips.

### BRIEF DESCRIPTION OF THE DRAWINGS

FIG. 1 is a perspective view of the sample tag connected to a container with a cutaway of the container showing the net inside.

FIG. 2 is a perspective view of the sample tag connected to the container.

FIG. 3 is a diagram of the tag.

FIG. 4 is an unfolded version of the tag showing the configuration before folding.

FIG. 5 is an exploded view of the tag.

FIG. 6 is a diagram of a rectangular container.

FIG. 7 is a diagram of the tag before folding showing flap positions.

The following call out list of elements can be a useful guide in referencing the call out numbers of the drawings.
20 Container
21 Container Lid
22 Container Body
23 Container Handle
24 Container Handle Grip
25 Net
26 Swatch Loop
27 Lid Seal Strip
28 Tag Opening
29 Loop Connector
30 Sample Tag
31 Swatch Material
32 First Frame Section
33 Second Frame Section
34 Third Frame Section
35 Fourth Frame Section
36 First Edge
37 Second Edge
38 Third Edge
39 Fourth Edge
40 Cover
41 First Cover Section
42 Second Cover Section
43 Third Cover Section
44 Fourth Cover Section
45 Cover Opening
46 First Inside Cover Opening Edge
47 Second Inside Cover Opening Edge
48 Third Inside Cover Opening Edge
49 Fourth Inside Cover Opening Edge
50 Base
51 First Base Section
52 Second Base Section
53 Third Base Section
54 Fourth Base Section
55 Contrast Background Section
56 First Adhesive Section
57 Second Adhesive Section
58 Third Adhesive Section
59 Fourth Adhesive Section
60 Base Tag Connector Opening
61 Tag Fold Line
62 Cover Tag Connector Opening
63 First Adhesive Corner
64 Second Adhesive Corner
65 Third Adhesive Corner
66 Fourth Adhesive Corner
67 Contrast Background Edge
68 Swatch Material Edge
69 Swatch Material Openings
70 Grid Arrangement
71 Intersections
72 Edge Tips
73 Translucent Core
74 Terminal Branch
75 Connected Area
76 Branching Fringe
77 Cover Inside Surface
78 Base Inside Surface
79 Adhesive Ring
80 Flap Closures
81 First Cover Flap
82 Second Cover Flap
83 Third Cover Flap
84 First Base Flap
85 Second Base Flap
86 Third-Base Flap
87 Flap Fold Over Area
88 Edge Gaps
89 Flap Fold Lines

### DETAILED DESCRIPTION OF THE EMBODIMENTS

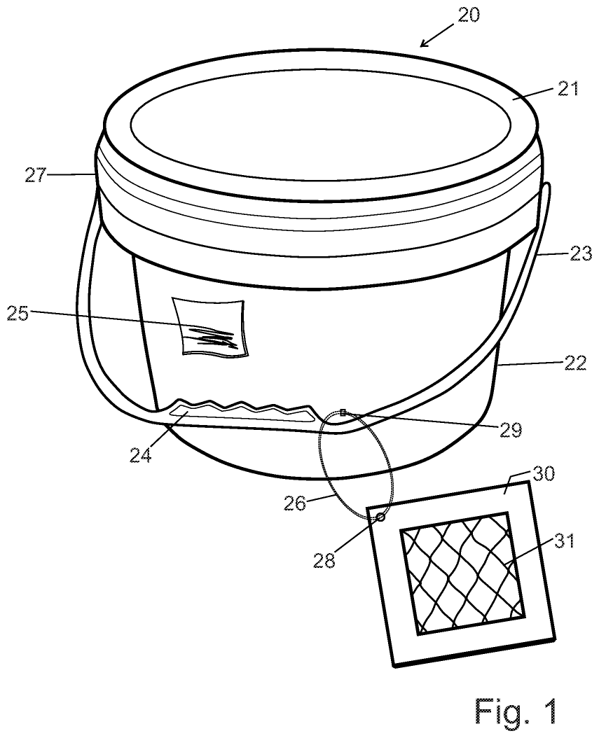

As seen in FIG. 1, The present invention is a swatch hangtag, also a sample tag 30 which provides a sample for potential customer of a cast net or other type of net 25 contained within a container 20. The container body 22 is opaque or translucent and may not provide a good view of the net 25. The shopper can see the swatch material 31 mounted to the sample tag 30. The sample tag 30 has a tag opening 28 punched in the sample tag 30. The tag opening 28 connects at a swatch loop 26 which in turn connects to the container handle 23. The container handle 23 may have a container handle grip 24, and the loop connector 29 can connect the swatch loop 26 to secure it to the container handle grip 24. The net 25 inside the container body 22 can be folded or rolled. A user can roll the net 25 and put it back in the container 20 after use. The container lid 21 can have a safety seal such as a lid seal strip 27 that a user removes upon first opening the container 20. The container handle 23 preferably connects at a left and right side of the container body 22 below the lid 21. The sample tag 30 holds the swatch material 31 along the periphery of the swatch material 31.

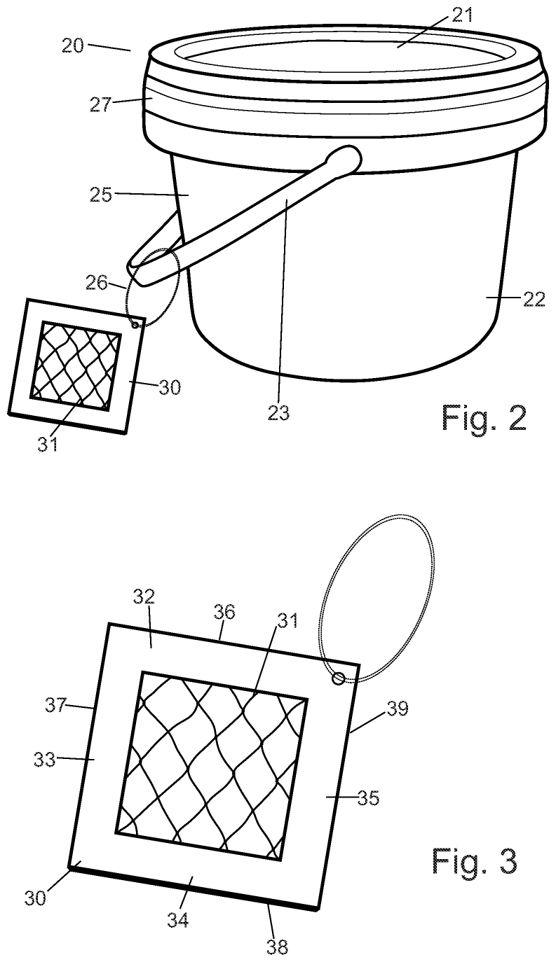

As seen in FIG. 2, the container 20 is formed as a bucket or tub with a lid 21 that fits over the container body 22. The swatch material 31 shows the user the material of the net 25 within the container 20.

As seen in FIG. 3, the sample tag 30 has a swatch material 31 retained in frame sections including a first frame section 32, a second frame section 33, a third frame section 34, and a fourth frame section 35. The first frame section 32 has a first edge 36 and a second frame section 33 has a second edge 37. The third frame section 34 has a third edge 38. The fourth frame section 35 has a fourth edge 39. The first frame section 32 is perpendicular to the second frame section 33 which is perpendicular to the third frame section 34, which is perpendicular to the fourth frame section 35. The first frame section 32 is parallel to the first edge 36. The second frame section 33 is parallel to the second edge 37. The third frame section 34 is parallel to the third edge 38. The fourth frame section 35 is parallel to the fourth edge 39.

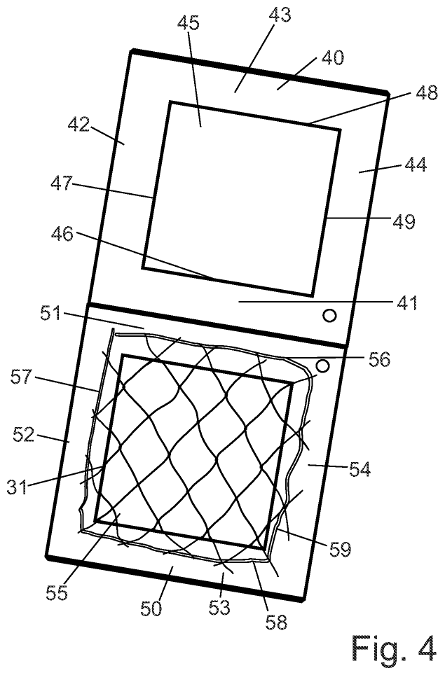

As seen in FIG. 4, the sample tag 30 can be built from a folded construction including a cover 40 folding over a base 50. The cover 40 has a first cover section 41, which is perpendicular to a second cover section 42, which is perpendicular to a third cover section 43, which is perpendicular to a fourth cover section 44. The cover opening 45 can be a rectangle or square with four edges. The first cover section 41 has a first inside cover opening edge 46. The second cover section 42 has a second inside cover opening edge 47. The third cover section 43 has a third inside cover opening edge 48. The fourth cover section 44 has a fourth inside cover opening edge 49.

The base 50 has a contrast background section 55 made of a material that contrasts to the swatch material 31 so that the swatch material 31 is in a high contrast and visible through the cover opening 45 when the cover opening 45 flips down over the contrast background section 55. Preferably, the contrast background section 55 is larger than and provides a background for the cover opening 45. The swatch material 31 can be adhesively bonded to the base 50 at a first adhesive section 56 on a first base section 51. The first base section 51 is perpendicular to a second base section 52. The swatch material can also be adhesively bonded to the base 50 where a second adhesive section 57 secures to a second base section 52. Which is perpendicular to a third base section 53, which is perpendicular to a fourth base section 54.

The first adhesive section 56, the second adhesive section 57, the third adhesive section 58, and the fourth adhesive section 59 are preferably perpendicular to each other and formed in a continuous loop which can be glue, and adhesive tape strip, or the like. Preferably a glue such as a hot melt glue can adhere the swatch material 31 to the base 50 and adhere the base 52 the cover 40 after the cover 40 is folded over onto the base 50.

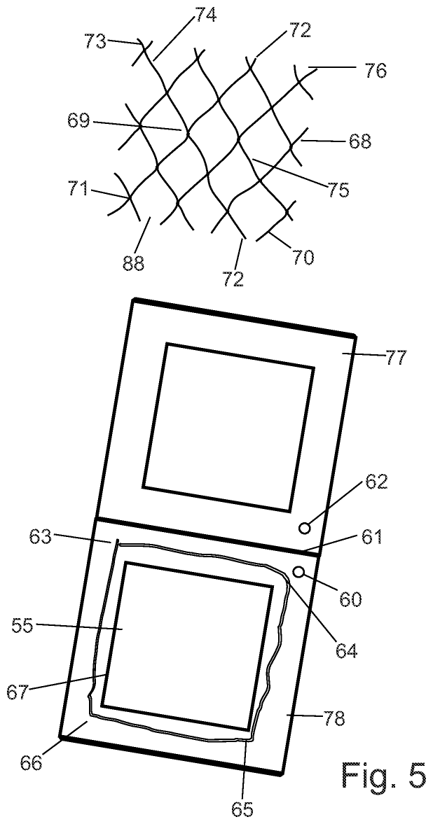

As seen in FIG. 5, the swatch material of the cast net is formed in a grid arrangement 70. The grid arrangement is interrupted when trimmed for sizing to fit over the contrast background edge 67. The trimmed sample material has a connected area 75 in the middle of the sample material and at the swatch material edge 68, the edge has edge tips 72 that extend outwardly in branching fringes 76 and edge gaps 88 between the branching fringes 76. The branching fringes 76 can have intersections 71 so that the terminal branches 74 constitute a single line of material between the branching French 76 and the terminal branch 74. The line of material can be a plastic line with the translucent core 73. The cast net will also have swatch material openings 69. The contrast background section 55 is seen through the swatch material openings 69.

The contrast background section 55 may have a contrast background edge 67. The cover inside surface 77 can secure to the base inside surface 78 at the adhesive ring 79. The adhesive ring 79 secures the grid arrangement 70 to the base inside surface 78. The adhesive ring 79 can be formed with straight lines having connections at corners such as a first adhesive corner 63, a second adhesive corner 64, a third adhesive corner 65, and a fourth adhesive corner 66. The contrast background section 55 also preferably has a contrast background edge 67. The branching fringes 76, and the edge tips 72 and the terminal branch 74 secure to the adhesive ring 79. The adhesive ring 79 also connects between the cover inside surface 77 and the base inside surface 78 at the edge gaps 88. The glue between the cover inside surface 77 and the base inside surface 78 secures at the edge gaps 88.

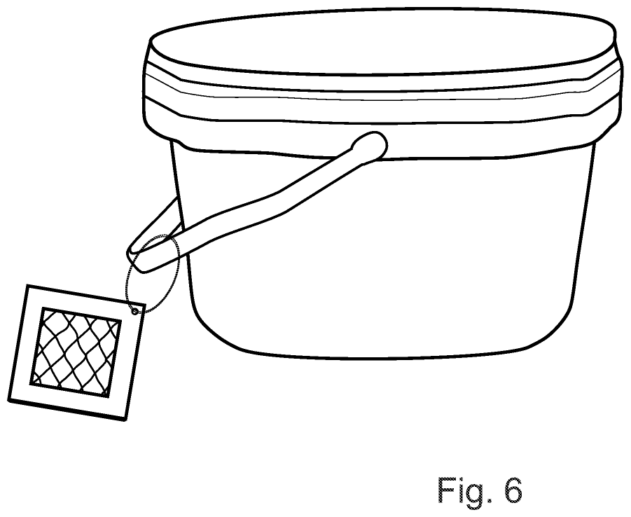

As seen in FIG. 6, the container can be oval or rectangular as well as a round tub.

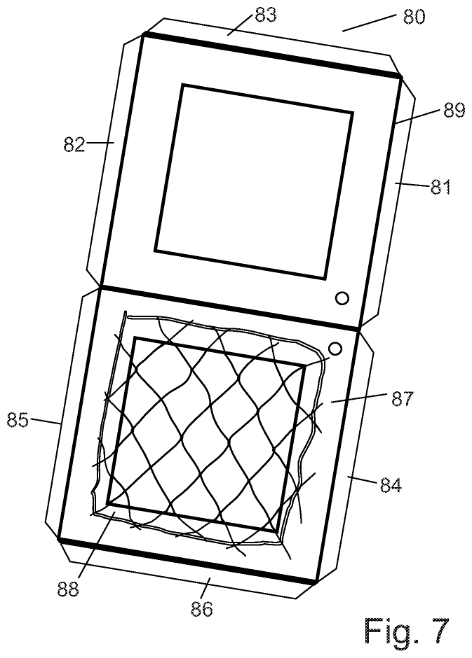

As seen in FIG. 7, the flap closures 80 can include a first cover flap 81, a second cover flap 82, and a third cover flap 83, extending from the cover. The flap closures 80 can also include a first base flap 84, a second base flap 85, and a third base flap 86 extending from the base. Each of the six flap closures 80 can have flap fold lines at the periphery of the cover and the base. The flap closures 80 may also fold over onto the base or cover at a flap fold over area 87 so that they fold over edge gaps 88. The flap closures 80 are shown as halfway folded rather than flat. The halfway folded configuration is preferred before closure to the edge gaps 88.

If the first base flap 84, the second base flap 85 and the third base flap 86 fold over the edge gaps 88, then the first cover flap 81 can fold over the first base flap 84, the third cover flap 83 can fold over the third base flap 86, and the second cover flap 82 can fold over the second base flap 85. Alternatively, the cover flaps can be folded onto the cover and then pressed to the base flaps which have been folded to the base. In this manner, the gap spacing between the cover and base is adjustable to match the thickness of the swatch material. With thicker swatch material, having a pair of flaps define a spacing provides superior connection. With thinner swatch material, the pair of flaps can be adjusted accordingly in orientation and folding topology for a secure connection of the swatch material to the base and cover.

1. A net swatch tag system comprising:
a. a container containing a net, wherein the container further includes a lid, wherein the lid is removable and attaches to the container;
b. a swatch tag, wherein the swatch tag is connected to the container, wherein the swatch tag retains a swatch material corresponding to the net.

2. The swatch tag of claim 1, further including a base formed on the swatch tag, wherein the base has a contrast background section, wherein the swatch material is mounted over the contrast background section.

3. The swatch tag of claim 2, further including a cover formed on the swatch tag, wherein the cover is configured to overlay the base and sandwich the swatch material between the cover and the base, wherein the cover has a cover opening, wherein the cover opening aligns to the contrast background section.

4. The swatch tag of claim 3, wherein the cover includes a first cover section, a second cover section, a third cover section and a fourth cover section, wherein the base includes a first base section, a second base section, a third base section, and a fourth base section, wherein the first cover section, second cover section, third cover section, fourth cover section, are elongated and perpendicular to each other.

5. The swatch tag of claim 3, wherein the swatch material adheres to the base at an adhesive ring, wherein the adhesive ring circumscribes the contrast background section.

6. The swatch tag of claim 3, wherein the swatch material has a translucent core.

7. The swatch tag of claim 3, wherein a first cover section fits over a first base section, wherein a second cover section fits over a second base section, wherein a third cover section fits over a third-base section.

8. The swatch tag of claim 3, wherein the cover is square or rectangular.

9. The swatch tag of claim 3, wherein the swatch material includes a connected area having a grid arrangement, and terminal branches extending to branch fringes, wherein the branch fringes extend outwardly to edge tips, wherein edge gaps are formed between the edge tips.

10. A net swatch tag system comprising:
a. a container containing a net; and
b. a swatch tag, wherein the swatch tag is connected to the container and further includes:
i. a swatch material corresponding to the net;
ii. a base; a contrast background section, wherein the contrast background section is formed on the base, wherein the swatch material is mounted over the contrast background section; and
iii. cover formed on the swatch tag, wherein the cover is configured to overlay the base and sandwich the swatch material between the cover and the base, wherein the cover has a cover opening, wherein the swatch material is visible through the cover opening.

11. The swatch tag of claim 10, wherein the cover includes a first cover section, a second cover section, a third cover section and a fourth cover section, wherein the base includes a first base section, a second base section, a third base section, and a fourth base section, wherein the first cover section, second cover section, third cover section, fourth cover section, are elongated and perpendicular to each other.

12. The swatch tag of claim 10, wherein the swatch material adheres to the base at an adhesive ring, wherein the adhesive ring circumscribes the contrast background section.

13. The swatch tag of claim 10, wherein the swatch material has a translucent core.

14. The swatch tag of claim 10, wherein a first cover section fits over a first base section, wherein a second cover section fits over a second base section, wherein a third cover section fits over a third-base section.

15. The swatch tag of claim 10, wherein the cover is square or rectangular.

16. The swatch tag of claim 10, wherein the swatch material includes a connected area having a grid arrangement, and terminal branches extending to branch fringes, wherein the branch fringes extend outwardly to edge tips, wherein edge gaps are formed between the edge tips.

17. The swatch tag of claim 10, further including flap closures formed on the cover which include a first cover flap, a second cover flap, and a third cover flap, wherein the first cover flap, the second cover flap, and the third cover flap extend outwardly from each other.

18. The swatch tag of claim 10, further including flap closures formed on the base which include a first base flap, a second base flap, and a third base flap, wherein the first base flap, the second base flap, and the third base flap extend outwardly from each other.
